(19) United States
(12) Patent Application Publication
(10) Pub. No.: US 2026/0178507 A1
(43) Pub. Date: Jun. 25, 2026

(54) Mixed Memory Architecture Cache Level

(71) Applicant: Advanced Micro Devices, Inc., Santa Clara, CA (US)

(72) Inventors: Gabriel Hsiuwei Loh, Bellevue, WA (US); Zachary Blair, San Jose, CA (US); Patrick James Shyvers, Fort Collins, CO (US); Onur Kayiran, West Henrietta, NY (US); Travis Henry Boraten, Austin, TX (US)

(73) Assignee: Advanced Micro Devices, Inc., Santa Clara, CA (US)

(21) Appl. No.: 18/990,434

(22) Filed: Dec. 20, 2024

(51) Int. Cl. G06F 12/0897

(52) U.S. Cl. CPC G06F 12/0897

(57) ABSTRACT

In accordance with the described techniques, a processor includes a cache controller and a cache system having a cache level with multiple memory architectures exhibiting different memory access latency and memory capacity characteristics. The cache controller is configured to receive a memory access request to a memory address, and perform lookups for a tag of the memory address in the multiple memory architectures in parallel.

### BACKGROUND

Processors, such as central processing units (CPUs), graphics processing units (GPUs), and other accelerator devices, are tasked with processing ever-increasing amounts of data. Access to this data is a significant factor in the speed at which the processor is able to process the data. Cache systems are data storage mechanisms within the processor architecture to speed up data access. Generally, a cache system is closer to the cores of a processor (in the context of data communication pathways) and therefore faster (in the context of memory access latency) than main memory of a device or system. Accordingly, accessing data more frequently from the cache system rather than the main memory increases memory access latency and improves overall computer performance.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement techniques for mixed memory architecture cache level.

FIG. 3 depicts a non-limiting example in which a cache controller performs parallel lookups in multiple memory architectures of a last level cache.

FIG. 4 depicts a non-limiting example of a processor die in accordance with one or more implementations.

FIG. 5 depicts a procedure in an example implementation of mixed memory architecture cache level.

### DETAILED DESCRIPTION

### Overview

In accordance with the described techniques, a processor includes a cache controller, a cache system, and a main memory. The cache system is organized in a cache hierarchy including multiple cache levels, e.g., a level one cache, a level two cache, and a level three or last level cache. In general, data stored in higher level caches (e.g., the level one cache) is accessible relatively faster than data stored in lower level caches (e.g., the last level cache), but the lower level caches have increased memory capacity than the higher level caches. Moreover, data stored in the cache system is accessible relatively faster than data stored in the main memory. In order to process a memory access request (e.g., a read request or a write request), therefore, the cache controller progressively performs lookups for the requested data in the level one cache, then the level two cache, then the last level cache. In response to a cache hit in a respective cache level (e.g., the requested data is present in the respective cache level), the cache controller accesses the requested data from the respective cache level. In response to cache misses in each of the cache levels (e.g., the requested data is not present in the cache system), the cache controller accesses the requested data from the main memory.

In cache design, increasing memory capacity of the cache system improves performance of the processor. Indeed, increasing the amount of data that is storable in the cache system increases cache hit rate. That is, increasing the memory capacity of the cache system increases the frequency with which data is accessed from the faster (in terms of memory access latency) cache system rather than the slower (in terms of memory access latency) main memory. One solution for increasing the memory capacity of the cache system includes integrating multiple memory architectures (e.g., static random access memory (SRAM) and a dynamic random access memory (DRAM)) within the cache system. By way of example, a mixed memory architecture cache design augments a traditional SRAM cache by incorporating an additional DRAM chip within the cache system.

Conventional mixed memory architecture cache designs, however, implement different memory architectures as different cache levels within a cache hierarchy. For instance, a conventional mixed memory architecture cache includes level one, level two, and level three caches that are implemented in SRAM, and a separate level four cache that is implemented in DRAM. This design choice worsens performance of the processor as compared to a traditional single memory architecture cache system when cache hit rate at the level four cache is low. This is because the lookups in different cache levels are performed consecutively. For example, a lookup is performed in the level three cache, then a lookup is performed in the level four cache after a cache miss in the level three cache, then the main memory access is initiated after a cache miss in the level four cache. Thus, additional memory access latency is incurred performing a lookup in the level four cache that would otherwise not be incurred in a single memory architecture cache system.

Accordingly, techniques for a mixed memory architecture cache level are described herein to perform lookups for a tag of a memory address in multiple memory architectures implemented in a same cache level in parallel. In accordance with the described techniques, the last level cache of the cache system includes a first memory architecture (e.g., SRAM) and a second memory architecture (e.g., DRAM). The first memory architecture exhibits decreased memory access latency and decreased memory capacity relative to the second memory architecture.

Here, the cache controller receives a memory access request to a memory address. To process the memory access request, the cache controller performs a first lookup for a tag of the memory address in the first memory architecture of the last level cache, and performs a second lookup for the tag of the memory address in the second memory architecture of the last level cache. Notably, the cache controller performs the first lookup and the second lookup in parallel. In response to the first lookup resulting in a cache hit, the cache controller accesses the data identified by the memory address from the first memory architecture of the cache system. In contrast, the cache controller accesses the data identified by the memory address from the second memory architecture of the cache system in response to the second lookup resulting in a cache hit. If both lookups result in a cache miss, the cache controller forwards the memory access request to main memory, e.g., to access the requested data from main memory.

Thus, in contrast to conventionally-configured mixed architecture caches, which incur the lookup latency of the first memory architecture and the lookup latency of the second memory architecture when the requested data is absent from the cache system, the described techniques solely incur the lookup latency of the second memory architecture. Indeed, by performing the tag lookups in the different memory architectures in parallel, the shorter duration lookup latency of the first memory architecture is entirely hidden by the longer duration lookup latency of the second memory architecture. Accordingly, the described techniques reduce memory access latency and improve overall computer performance, as compared to conventional approaches.

In some aspects, the techniques described herein relate to a processor comprising a cache system having a cache level with multiple memory architectures exhibiting different memory access latency and memory capacity characteristics, and a cache controller to receive a memory access request to a memory address, and perform lookups for a tag of the memory address in the multiple memory architectures in parallel.

In some aspects, the techniques described herein relate to a processor, wherein the processor is communicatively coupled to a memory, and the cache controller is configured to forward the memory access request to the memory in response to the lookups resulting in cache misses in the multiple memory architectures.

In some aspects, the techniques described herein relate to a processor, wherein a first memory architecture of the multiple memory architectures exhibits decreased memory access latency and decreased memory capacity relative to a second memory architecture of the multiple memory architectures.

In some aspects, the techniques described herein relate to a processor, wherein the cache controller is configured to access requested data of the memory access request from the first memory architecture in response to a lookup for the tag resulting in a cache hit in the first memory architecture.

In some aspects, the techniques described herein relate to a processor, wherein the cache controller is configured to access requested data of the memory access request from the second memory architecture in response to a lookup for the tag resulting in a cache hit in the second memory architecture.

In some aspects, the techniques described herein relate to a processor, wherein the processor is communicatively coupled to a memory, and the cache controller is configured to speculatively forward the memory access request to the memory in response to a first lookup for the tag resulting in a cache miss in the first memory architecture and before a second lookup for the tag has completed in the second memory architecture.

In some aspects, the techniques described herein relate to a processor, wherein the second memory architecture is a dynamic random access memory, the memory access request maps to a row of the dynamic random access memory, and the cache controller is configured to issue an activate command to open the row in a data array of the dynamic random access memory before a lookup for the tag in a tag array of the dynamic random access memory has completed.

In some aspects, the techniques described herein relate to a processor, wherein the cache controller is configured to swap a cache line that contains requested data of the memory access request from the second memory architecture to the first memory architecture in response to a lookup for the tag resulting in a cache hit in the second memory architecture.

In some aspects, the techniques described herein relate to a processor, wherein the cache controller is configured to generate at least one of a reuse prediction and a spatial locality prediction for a cache line to be installed into the cache level, and install the cache line into the first memory architecture or the second memory architecture based on at least one of the reuse prediction and the spatial locality prediction.

In some aspects, the techniques described herein relate to a processor, wherein the cache controller is configured to prefetch data into the first memory architecture of the cache level at a first rate, and prefetch data into the second memory architecture of the cache level at a second rate that is different than the first rate.

In some aspects, the techniques described herein relate to a processor, wherein the first memory architecture and the second memory architecture are configured as set-associative caches having a same number of sets, and the cache controller is configured to perform the lookups in the multiple memory architectures using a same index function.

In some aspects, the techniques described herein relate to a processor, wherein the first memory architecture and the second memory architecture are configured as set-associative caches having different numbers of sets, and the cache controller is configured to perform a first lookup for the tag in the first memory architecture using a first index function, and perform a second lookup for the tag in the second memory architecture using a second index function.

In some aspects, the techniques described herein relate to a processor, wherein one or more of the multiple memory architectures are integrated in the processor via three-dimensional stacking.

In some aspects, the techniques described herein relate to a device comprising a processor including a cache system and a cache controller, the cache system including a cache level having a static random access memory (SRAM) portion and a dynamic random access memory (DRAM) portion, the cache controller configured to receive a memory access request to a memory address, and perform lookups for a tag of the memory address in the SRAM portion and the DRAM portion in parallel.

In some aspects, the techniques described herein relate to a device, wherein the cache controller is configured to access requested data of the memory access request from the SRAM portion in response to a first lookup for the tag resulting in a cache hit in the SRAM portion, or access the requested data from the DRAM portion in response to a second lookup for the tag resulting in a cache hit in the DRAM portion.

In some aspects, the techniques described herein relate to a device, further comprising a memory communicatively coupled to the processor, wherein the cache controller is configured to speculatively forward the memory access request to the memory in response to a first lookup for the tag resulting in a cache miss in the SRAM portion and before a second lookup for the tag has completed in the DRAM portion.

In some aspects, the techniques described herein relate to a device, wherein the cache controller is configured to access a cache line of the memory address from the DRAM portion in response to a lookup for the tag resulting in a cache hit in the DRAM portion, and swap the cache line from the DRAM portion to the SRAM portion based on a counter value of the cache line that indicates a number of cache hits to the cache line.

In some aspects, the techniques described herein relate to a device, wherein the cache controller is configured to prefetch a cache line into the SRAM portion rather than the DRAM portion based on a lookahead distance of the cache line falling below a threshold, the lookahead distance representing a number of instruction cycles to be executed before the cache line is predicted to be accessed.

In some aspects, the techniques described herein relate to a device, wherein the cache controller is configured to prefetch a cache line into the DRAM portion rather than the SRAM portion based on a lookahead distance of the cache line equaling or exceeding a threshold, the lookahead distance representing a number of instruction cycles to be executed before the cache line is predicted to be accessed.

In some aspects, the techniques described herein relate to a method comprising receiving a memory access request to a memory address, and searching for a tag of the memory address in a first memory architecture and a second memory architecture of a cache level in parallel, the first memory architecture exhibiting decreased memory access latency and decreased memory capacity relative to the second memory architecture.

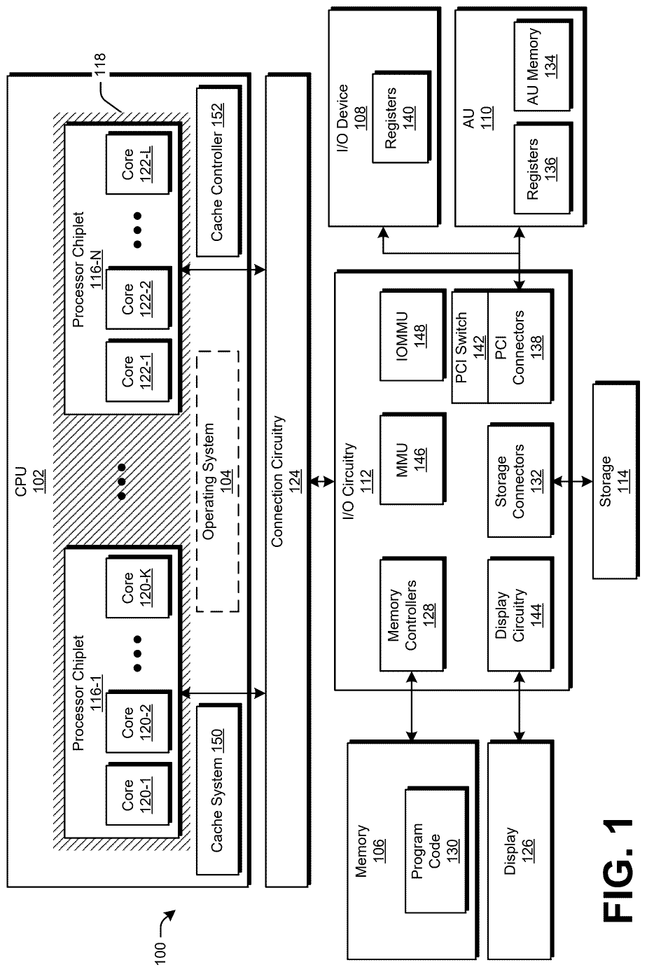

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

In this example, the CPU 102 includes a cache system 150, which is a device and/or system that is used to store information, such as for use by the CPU 102. In one or more implementations, the cache system 150 corresponds to semiconductor memory where data is stored within memory cells on one or more integrated circuits. In various examples, the cache system 150 corresponds to or includes volatile memory, examples of which include RAM, SRAM, DRAM, SDRAM, latch arrays, and embedded DRAM (eDRAM). Additionally or alternatively, the cache system 150 corresponds to or includes non-volatile memory, such as phase change memory (PCM), spin-transfer torque magneto-resistive RAM (STT-MRAM), ferroelectric RAM (FeRAM), and so on. Thus, the cache system 150 is configurable in a variety of ways that support mixed memory architecture cache level without departing from the spirit or scope of the described techniques. In general, the cache system 150 is representative of a cache hierarchy having multiple cache levels. In accordance with such a cache hierarchy, data is accessible from higher level caches faster than lower level caches, but the higher level caches have reduced memory capacity than the lower level caches. In addition, data is accessible from the cache system 150 faster than the memory 106.

As shown, the CPU 102 additionally includes a cache controller 152, which is an electronic circuit configured to manage data within the cache system 150. For example, the cache controller 152 manages cache installation, cache eviction, cache coherence, and cache prefetching. In accordance with the described techniques for mixed memory architecture cache level, the cache controller 152 is configured to perform lookups in multiple memory architectures of a particular cache level (e.g., last level cache) in parallel. While the cache controller 152 is depicted as included in the CPU 102, the cache controller 152 is included in and/or implemented by one or more different components of the processing system 100, such as the CPU 102 and the AU 110. In at least one implementation, the cache controller 152 or instances of the cache controller 152 are included in at least two of the depicted components of the processing system 100. By way of example, the cache controller 152 may be included in or otherwise implemented by at least the CPU 102 and the AU 110.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

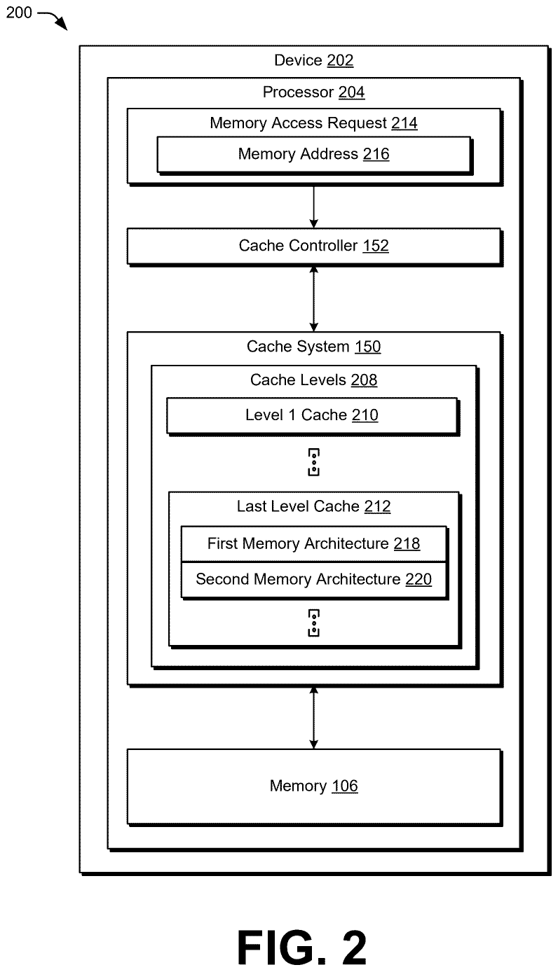

FIG. 2 is a block diagram of a non-limiting example system 200 to implement techniques for mixed memory architecture cache level. The system 200 includes a device 202 having a processor 204 and a memory 206. Further, the processor 204 includes the cache system 150 and the cache controller 152 of FIG. 1. In various examples, the device 202 is configured to implement the processing system 100 of FIG. 1, and the device 202 is configured as any of the example devices discussed above with reference to FIG. 1.

In accordance with the described techniques, the processor 204, the memory 206, the cache system 150, and the cache controller 152 are coupled to one another via one or more wired and/or wireless connections. Example wired connections include, but are not limited to, buses (e.g., a data bus), interconnects, traces, and planes. The processor 204 is an electronic circuit configured to read, translate, and execute instructions of a program, application, and/or operating system. In one example, the processor 204 is the CPU 102 depicted and described above with reference to FIG. 1. However, this example is not to be construed as limiting. Rather, examples of the processor 204 include, but are not limited to, a central processing unit (CPU), a graphics processing unit (GPU), a field programmable gate array (FPGA), a digital signal processor (DSP), an application specific integrated circuit (ASIC), an acceleration processor, or any other type of processor.

The memory 206 is a device and/or system that is used to store information, such as for use by the processor 204. In one or more implementations, the memory 206 corresponds to semiconductor memory where data is stored within memory cells on one or more integrated circuits. In at least one example, the memory 206 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 206 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 206 is configurable in a variety of ways that support mixed memory architecture cache level without departing from the spirit or scope of the described techniques. In one or more implementations, the memory 206 is representative of and/or corresponds to the memory 106 of FIG. 1.

As shown, the cache system 150 includes multiple cache levels 208, examples of which are illustrated as a level 1 cache 210 through a last level cache 212. By way of example and not limitation, the processor 204 is a multi-core processor, and each respective core includes a level 1 cache and a level 2 cache that are native to the respective core. Continuing with this example, the processor 204 includes a last level cache 212 that is shared among all cores of the processor 204. While an example of the last level cache 212 is a level 3 cache, the last level cache 212 is an even lower cache level (e.g., a level 4 cache), in some examples. In general, data stored in higher level caches (e.g., the level 1 cache 210) is accessible relatively faster than data stored in lower level caches (e.g., the last level cache 212), but the lower level caches have increased memory capacity than the higher level caches. Moreover, data stored in the cache system 150 is accessible relatively faster than data stored in the memory 206, e.g., the main memory of the device 202. It is to be appreciated that the processor 204 can include cache systems with different numbers of cache levels and different hierarchical structures without departing from the spirit or scope of the described techniques. For instance, the cache hierarchy includes any number of cache levels, and the last level cache 212 is the “lowest” cache level 208 of the cache hierarchy.

The cache controller 152 is an electronic circuit configured to manage data within the cache system 150. In one or more examples, the cache controller 152 manages cache installation to determine where in the cache system 150 (e.g., which cache level 208 and/or which portion of a particular cache level 208) incoming data is to be stored. Additionally or alternatively, the cache controller 152 implements one or more cache eviction policies (e.g., least recently used (LRU), first-in-first-out (FIFO), least frequently used (LFU), random replacement, and so on) to determine which data is to be evicted from a cache level 208 to make room for incoming data when the cache level 208 is full. In various implementations, the cache controller 152 is responsible for maintaining cache coherence to ensure that all copies of data are consistent across different memory resources of the device 202, e.g., the memory 206 and different caches operated on by different cores of the processor 204. In some examples, the cache controller 152 also manages cache prefetching to predict data that is to be accessed in the future (e.g., by an application running on one or more cores of the processor 204) and preemptively load the predicted data into the cache system 150.

In one or more implementations, the cache controller 152 is configured to receive a memory access request 214 and access requested data in the cache system 150 or the memory 206. In variations, the memory access request 214 is a read request or a write request. Broadly, a read request is an instruction or command submitted by a core of the processor 204 (e.g., by an application running on the core) instructing the cache controller 152 to load data from the cache system 150 or the memory 206 into the core for further processing by the core. Furthermore, a write request is an instruction or command submitted by a core of the processor 204 (e.g., by an application running on the core) instructing the cache controller 152 to store data (e.g., data that has been processed and/or modified by the core) in the cache system 150 or the memory 206. As shown, the memory access request 214 includes a memory address 216, which is a unique identifier that specifies one or more locations in the cache system 150 and/or the memory 206 where the requested data of the memory access request 214 is located. Notably, information is communicated between the processor cores, the cache controller 152, the cache system 150, and the memory 206 in fixed-length units of data transfer called “cache lines.”

Given the above, the cache controller 152 fulfills the memory access request 214 by progressively checking the cache system 150 (from higher level caches to lower level caches), then the memory 206 for the data identified by the memory address 216. For example, the cache controller 152 performs lookups for a tag of the memory address 216 in successive cache levels 208, e.g., the level 1 cache 210, then the level 2 cache, then the last level cache 212. Broadly, a lookup is an operation performed by the cache controller 152 to determine whether data of a memory address is present in a cache or cache level 208. In cache operations, a “cache hit” occurs at a cache level 208 when a tag of the memory address 216 is present in the cache level 208. In contrast, a “cache miss” occurs at a cache level 208 when a tag of the memory address 216 is absent from the cache level. Notably, a tag is a component (e.g., a specified range of bits) of a memory address 216 that is used for determining whether the data specified by the memory address 216 is present in a cache level 208. By way of example, each cache level 208 includes a tag array including a plurality of tags, each uniquely identifying a different cache line that is present in the cache level 208. Thus, a tag being present in a cache level 208 means that the data specified by the memory address 216 is also present in a data array of the cache level 208.

The cache controller 152 accesses the requested data from a respective cache level 208 (e.g., reads data from or writes data to the respective cache level 208) in response to the lookup resulting in a cache hit at the respective cache level 208. In response to a lookup resulting in a cache miss at a respective cache level 208 (e.g., the level 2 cache), however, the cache controller 152 performs an additional lookup for the tag of the memory address 216 in the next successive cache level 208, e.g., the last level cache 212. If a lookup for the tag of the memory address 216 results in a cache miss in the last level cache 212, the cache controller 152 forwards the memory access request 214 to the memory 206 and accesses the requested data from the memory 206, e.g., reads data from or writes data to the memory 206.

Traditional cache system designs include only one base memory architecture, e.g., SRAM. Some cache systems, on the other hand, augment this cache system design to include an additional memory architecture (e.g., DRAM) that exhibits increased memory capacity in comparison to the base memory architecture. By extending the cache capacity of the cache system, mixed memory architecture caches increase cache hit rate and improve device performance. However, conventional mixed memory architecture cache systems implement the different memory architectures as separate cache levels. For example, a conventionally-configured mixed memory architecture cache system include level 1 caches, level 2 caches, and a level 3 cache implemented in SRAM, and a separate level 4 cache implemented in DRAM.

This design choice worsens performance of the system as compared to a traditional single memory architecture cache system in certain scenarios, e.g., when cache hit rate at the level 4 cache is low. This is because the lookups in the different cache levels are performed consecutively. By way of example, a lookup is performed in the level 3 cache, then a lookup is performed in the level 4 cache after a cache miss in the level 3 cache, then the main memory access is initiated after a cache miss in the level 4 cache. Thus, on a cache miss in the level 4 cache, additional memory access latency is incurred performing a lookup in the level 4 cache that would otherwise not be incurred in a single memory architecture cache system. This problem is further exacerbated by the notion that, while the additional memory architecture (e.g., DRAM) exhibits increased memory capacity, it comes at the expense of increased memory access latency relative to the base memory architecture, e.g., SRAM.

Accordingly, techniques for a mixed memory architecture cache level are described herein to perform lookups for a tag of a memory address in multiple memory architectures implemented in a same cache level in parallel. As part of this, the last level cache 212 includes a first memory architecture 218 and a second memory architecture 220. Generally, the first memory architecture 218 exhibits decreased memory access latency and decreased memory capacity relative to the second memory architecture 220. In at least one specific but non-limiting example, the first memory architecture 218 is SRAM and the second memory architecture 220 is DRAM. It is to be appreciated, however, that the described techniques support a variety of memory architecture combinations. Here, memory access latency refers to an amount of time between when a lookup is initiated in a respective memory architecture and when the corresponding data is accessed from the respective memory architecture or when the cache controller 152 has determined that the lookup results in a cache miss in the respective memory architecture. Further, memory capacity refers to an amount of data that is storable in a respective memory architecture. In one or more implementations, the first memory architecture 218 and/or the second memory architecture 220 are integrated in the processor 204 via three-dimensional stacking.

To process the memory access request 214 in accordance with the described techniques, the cache controller 152 progressively searches the cache levels 208 according to the cache hierarchy. Here, the memory access request 214 reaches the last level cache 212 because lookups for the tag of the memory address 216 result in cache misses in the higher cache levels 208, e.g., the level 1 cache 210 and the level 2 cache. Accordingly, the cache controller 152 initiates a first lookup for the tag of the memory address 216 in the first memory architecture 218. In addition, the cache controller 152 initiates a second lookup for the tag of the memory address 216 in the second memory architecture 220. The cache controller 152 performs the first lookup in the first memory architecture 218 and the second lookup in the second memory architecture 220 in parallel.

In response to the first lookup resulting in a cache hit in the first memory architecture 218, the cache controller 152 accesses the data identified by the memory address 216 in the first memory architecture 218. In response to the second lookup resulting in a cache hit in the second memory architecture 220, the cache controller 152 accesses the data identified by the specified memory address 216 in the second memory architecture 220. Furthermore, the cache controller 152 forwards the memory access request 214 to the memory 206 in response to the first lookup and the second lookup resulting in cache misses in both the first memory architecture 218 and the second memory architecture 220, and accesses the data identified by the memory address 216 in memory 206.

Accordingly, the described techniques support parallel tag lookups in the first memory architecture 218 and the second memory architecture 220 of the last level cache 212. By doing so, the described techniques overlap the lookup latency of the second memory architecture 220 with the lookup latency of the first memory architecture 218. In contrast to conventional mixed memory architecture caches which incur the lookup latency of both memory architectures when requested data is absent from the cache system, the described techniques solely incur the lookup latency in the second memory architecture 220. This is because the shorter duration lookup latency of the first memory architecture 218 is entirely hidden by the longer duration lookup latency of the second memory architecture 220. Thus, the described techniques increase cache hit rate through inclusion of the second memory architecture 220, and also decrease memory access latency in comparison to conventional mixed memory architecture caches, thereby improving performance of the device 202. Although examples are depicted and described herein with respect to a first memory architecture 218 and a second memory architecture 220, it is to be appreciated that the described techniques are extendable to perform lookups in three or more memory architectures of a singular cache level in parallel.

Moreover, while a single cache controller 152 is depicted and described herein, it is to be appreciated that the cache controller 152 is implemented as a collection of cache controllers, e.g., at least one cache controller per cache level 208 in the cache system 150. In variations, the cache controller 152 includes a single cache controller for managing data in the last level cache 212, or the cache controller 152 includes different cache controllers for managing data in different memory architectures of the last level cache 212. In an example in which the first memory architecture 218 is implemented in SRAM and the second memory architecture 220 is implemented in DRAM, for instance, the cache controller 152 includes a first cache controller for managing data in the level 1 cache 210, a second cache controller for managing data in the level 2 cache, an SRAM cache controller for managing data in the SRAM portion of the last level cache 212, and a DRAM cache controller for managing data the DRAM portion of the last level cache 212. Accordingly, operations (e.g., lookups) performed by the cache controller 152 with respect to a particular cache level or a particular memory architecture of the particular cache level, as discussed herein, are operations (e.g. lookups) performed by one of a collection of cache controllers assigned to manage data in the particular cache level or the particular memory architecture of the particular cache level.

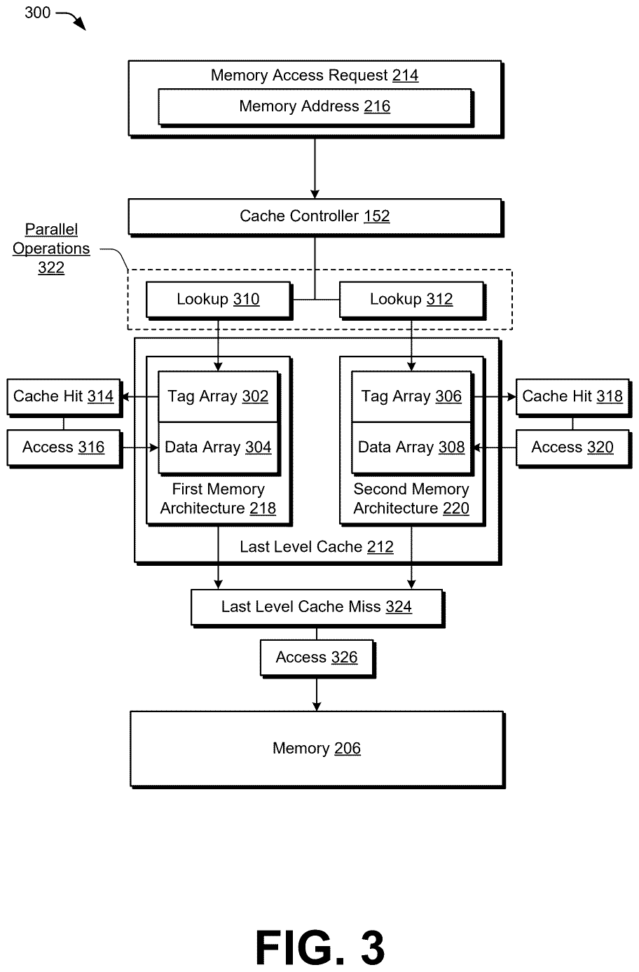

FIG. 3 depicts a non-limiting example 300 in which a cache controller performs parallel lookups in multiple memory architectures of a last level cache. In the example 300, the first memory architecture 218 includes a tag array 302 and a data array 304, and the second memory architecture 220 includes a tag array 306 and a data array 308. The tag array 302 includes a plurality of tags, each uniquely identifying a different cache line that is present in the first memory architecture 218 of the last level cache 212, and the data array 304 includes the corresponding cache lines that are cached in the first memory architecture 218. Similarly, the tag array 306 includes a plurality of tags, each uniquely identifying a different cache line that is present in the second memory architecture 220, and the data array 308 includes the corresponding cache lines that are cached in the second memory architecture 220.

In accordance with the described techniques, the first memory architecture 218 and the second memory architecture 220 include or correspond to set-associative caches organized into ways and sets. For example, a 4-way set associative cache includes a plurality of sets, and each set includes four cache lines. Furthermore, the memory address 216 includes three components, an index, a tag, and an offset. The index is a range of bits in the memory address 216 that identifies which set the requested data resides in. The tag is a range of bits in the memory address 216 that is compared to the tags in the tag array to determine whether a corresponding cache line that contains the requested data resides in the cache. The offset is a range of bits in the memory address 216 that identifies the exact byte of the requested data within the corresponding cache line, e.g., since a cache line contains multiple bytes.

Thus, to perform a lookup in a set-associative cache, the cache controller 152 identifies a particular set of the cache using the index, and searches for a tag in the tag array of the particular set that matches the tag of the memory address 216. To identify the particular set, the cache controller 152 uses an index function to extract the particular subset of bits within the memory address 216 corresponding to the index. If a matching tag exists in the particular set of the tag array, the result is a cache hit, and the cache controller 152 accesses the corresponding cache line from the data array. If a matching tag does not exist in the particular set of the tag array, the result is a cache miss.

Given the above, the cache controller 152 is configured to perform lookups 310, 312 in the first memory architecture 218 and the second memory architecture 220, respectively, configured as set-associative caches. To perform the lookup 310, the cache controller 152 identifies a particular set in the first memory architecture 218 based on the index of the memory address 216. Furthermore, the cache controller 152 searches the particular set of the tag array 302 for a tag that matches the tag of the memory address 216. If a matching tag is found in the tag array 302, the result of the lookup 310 is a cache hit 314, and the cache controller 152 accesses the corresponding cache line from the data array 304, e.g., access 316. In one or more implementations, the cache controller 152 initiates the access 316 to the corresponding cache line immediately in response to the cache hit 314, e.g., before the lookup 312 in the second memory architecture 220 has completed.

Similarly, to perform the lookup 312, the cache controller 152 identifies a particular set in the second memory architecture 220 based on the index of the memory address 216. In addition, the cache controller 152 searches the particular set of the tag array 306 for a tag that matches the tag of the memory address 216. If a matching tag is found in the tag array 306, the result of the lookup 312 is a cache hit 318, and the cache controller 152 accesses the corresponding cache line from the data array 308, e.g., access 320. As shown, the lookups 310, 312 are parallel operations 322, e.g., the cache controller performs the lookups 310, 312 in parallel.

In one or more implementations, the first memory architecture 218 and the second memory architecture 220 have the same number of sets, but different numbers of ways. By way of example and not limitation, the first memory architecture 218 is a 4-way set associative cache and the second memory architecture 220 is a 6-way set associative cache. In this example, the second memory architecture 220 is conceptualizable as an extension of the set associativity of the first memory architecture 218, and as such, the memory architectures 218, 220 combine to form a 10-way set associative cache. Since both memory architectures 218, 220 have the same number of sets, a single index function is used to extract the index from the memory address 216 for both lookups 310, 312. Alternatively, the first memory architecture 218 and the second memory architecture 220 have different number of sets, and different numbers of ways. Due to the different numbers of sets in the different memory architectures 218, 220, the cache controller 152 uses a first index function to extract the index from the memory address 216 for purposes of performing the lookup 310, and uses a second, different index function to extract the index from the memory address 216 for purposes of performing the lookup 312.

In response to the lookup 310 and the lookup 312 both resulting in a cache miss (e.g., the last level cache miss 324), the cache controller 152 forwards the memory access request 214 to the memory 206. In other words, the cache controller 152 accesses the data specified by the memory address 216 from the memory 206, e.g., access 326.

In one or more implementations, the cache controller 152 is configured to speculatively forward the memory access request 214 to the memory 206 immediately in response to the lookup 310 in the first memory architecture 218 resulting in a cache miss, and before the lookup 312 in the second memory architecture 220 has completed. By doing so, the described techniques reduce memory access latency in scenarios in which both lookups 310, 312 result in a cache miss, e.g., the last level cache miss 324. This is because the memory access latency associated with accessing the requested data from the memory 206 is partially overlapped with the lookup latency of the lookup 312, e.g., which is of a longer duration than the lookup 310.

The speculative main memory access protocol induces extra network bandwidth consumption for the device 202 in scenarios in which the lookup 312 results in the cache hit 318 in the second memory architecture 220. However, the described techniques alleviate the extra network bandwidth consumption by speculatively forwarding the memory access request 214 to the memory 206 solely in response to the lookup 310 resulting in a cache miss in the first memory architecture 218, rather than speculatively forwarding the memory access request 214 to the memory 206 for all memory access requests 214 that reach the last level cache 212.

In one or more implementations, the cache controller 152 is configured to implement probabilistic data structures (e.g., Bloom filters and/or counting Bloom filters) to predict whether the lookups 310, 312 will result in a cache hit or a cache miss. A Bloom filter is a memory-efficient probabilistic data structure that is used to efficiently predict whether a cache line is in a cache, e.g., the first memory architecture 218 or the second memory architecture 220. Bloom filters can produce negative outputs (e.g., a determination that a cache line is definitely not in the cache), or a positive output, e.g., a determination that a cache line might be in the cache. In other words, Bloom filters do not produce false negatives (e.g., a determination that a cache line is not in the cache when the cache line is, in fact, in the cache), but can produce false positives, e.g., a determination that the cache line is in the cache when the cache line is, in fact, not in the cache.

Given the above, the cache controller 152 includes a first Bloom filter including indications of cache lines (e.g., hashes of tags of the cache lines) that are in the first memory architecture 218, and a second Bloom filter including indications of cache lines (e.g., hashes of tags of the cache lines) that are in the second memory architecture 220. Accordingly, the cache controller 152 passes the tag of the memory address 216 through the first and second Bloom filters to predict whether the corresponding cache lines are in the first and second memory architectures 218, 220, respectively, e.g., whether the lookups 310, 312 will result in a cache miss or a cache hit.

In a first scenario, the first Bloom filter produces a positive output (e.g., the cache line identified by the memory address 216 is potentially in the first memory architecture 218) and the second Bloom filter produces a negative output, e.g., the cache line identified by the memory address 216 is definitely not in the second memory architecture 220. In this scenario, the cache controller 152 performs the lookup 310 in the first memory architecture 218, but does not perform the lookup 312 in the second memory architecture 220. In response to the lookup 310 resulting in a cache miss in the first memory architecture 218, the cache controller 152 immediately forwards the memory access request 214 to the memory 206.

In a second scenario, the first Bloom filter produces a negative output and the second Bloom filter produces a positive output. In this scenario, the cache controller 152 performs the lookup 312 in the second memory architecture 220, but does not perform the lookup 310 in the first memory architecture 218. If a false positive rate at the second Bloom filter exceeds or equals a threshold, the cache controller 152 forwards the memory access request 214 to the memory 206 immediately upon initiating the lookup 312, e.g., before the lookup 312 has completed. If the false positive rate at the second Bloom filter is below the threshold, the cache controller 152 forwards the memory access request 214 to memory 206 in response to the lookup 312 resulting in a cache miss.

In a third scenario, the first Bloom filter and the second Bloom filter produce positive outputs. In this scenario, the cache controller 152 performs both lookups 310, 312 in parallel. If a false positive rate at the second Bloom filter exceeds or equals a threshold, the cache controller 152 forwards the memory access request 214 to the memory 206 in response to the lookup 310 resulting in a cache miss, e.g., before the lookup 312 has completed. If the false positive rate at the second Bloom filter falls below the threshold, the cache controller 152 forwards the memory access request 214 to memory 206 in response to both lookups 310, 312 resulting in a cache miss, e.g., the last level cache miss 226.

In a fourth scenario, the first Bloom filter and the second Bloom filter produce negative outputs. In this scenario, the cache controller 152 forwards the memory access request 214 to memory 206 immediately in response to receiving the negative outputs from the Bloom filters, e.g., without performing the lookups 310, 312.

As previously mentioned, the second memory architecture 220 is implemented in DRAM in various implementations. In these implementations, each set of the second memory architecture 220 corresponds to a row of the DRAM, and as such, the index of the memory address 216 maps to a particular row of the DRAM. Given this, the cache controller 152 issues an early activate command to open the row in the data array 308 of the DRAM identified by the index of the memory address 216 before the lookup 312 has completed in the tag array 306 of the second memory architecture 220, e.g., DRAM. By doing so, the described techniques reduce overall memory access latency associated with accessing the requested data from the second memory architecture 220 by overlapping the row activate latency with the tag lookup latency of the lookup 312, e.g., the latency of searching for the tag of the memory address 216 in the tag array 306.

In one or more implementations, the cache controller 152 issues the early activate command for every memory access request 214 that reaches the last level cache 212. For example, the cache controller 152 issues the early activate command concurrently with initiating the lookups 310, 312, e.g., immediately responsive to identifying the set (e.g., the row of the DRAM) that maps to the memory address 216. Alternatively, the cache controller 152 issues the early activate command for some, but not all, memory access requests 214 that reach the last level cache 212. In one example, the cache controller 152 issues the early activate command in response to the lookup 310 resulting in a cache miss in the first memory architecture 218, thereby refraining from issuing the early activate command when the lookup 310 results in a cache hit in the first memory architecture 218. By selectively issuing the early activate request in the manner described, the described techniques reduce power consumption resulting from opening rows that are not ultimately accessed.

In accordance with the described techniques, the cache controller 152 is configured to swap cache lines between the memory architectures 218, 220 in accordance with one or more cache swapping policies. For example, the cache controller 152 identifies a promotion cache line to be transferred from the second memory architecture 220 to the first memory architecture 218 based on a number of cache hits to the cache line equaling or exceeding a threshold number. In one example, the threshold number is one. For instance, the cache controller 152 identifies a cache line as a promotion cache line in response to one lookup 312 resulting in a cache hit to the cache line since the cache line was inserted into the second memory architecture 220.

Additionally or alternatively, the threshold number is two or more. To accommodate this functionality, each tag in the tag array 306 includes a hit counter, which indicates a number of cache hits to the corresponding cache line since being inserted in the second memory architecture 220 of the last level cache 212. In one example, the hit counter of a tag is a single bit, and the threshold number is two. In this example, when a cache line is initially inserted in the second memory architecture 220, the hit counter is set to zero. In response to a lookup 312 resulting in a cache hit 318 to the cache line, the cache controller 152 increments the hit counter of the corresponding tag in the tag array 306 without initiating a cache line swap. In response to a subsequent lookup 312 resulting in a cache hit to the cache line, the cache controller 152 identifies the cache line as a promotion cache line to be transferred to the first memory architecture 218, e.g., based on the hit counter being set to one.

Once the promotion cache line is identified, the cache controller 152 uses one or more cache eviction policies (e.g., LRU, FIFO, LFU, random replacement) to identify a demotion cache line to be transferred to the second memory architecture 220 to make room for the incoming promotion cache line. Here, the cache controller 152 moves the promotion cache line from the second memory architecture 220 to the first memory architecture 218, and moves the demotion cache line from the first memory architecture 218 to the second memory architecture 220. It should be noted that the hit counter occupies more than one bit in respective tags of the tag array in variations, and as such, the threshold number of cache hits that trigger a cache line swap between memory architectures 218, 220 is configurable as any suitable number

The reason for swapping a cache line from the second memory architecture 220 to the first memory architecture 218 based on cache hit(s) to the cache line is based on the notion of temporal locality. Broadly, temporal locality is a principle referring to the tendency of the processor 204 to repeatedly access a same memory location in a short duration of time. Thus, by swapping a recently accessed cache line from the second memory architecture 220 to the first memory architecture 218, the described techniques service the likely future accesses to the same cache line faster. This is because the first memory architecture 218 exhibits decreased memory access latency relative to the second memory architecture 220. As mentioned above, the threshold number of cache hits to a cache line that trigger the cache line swap is two or more in various implementations. This is beneficial in various implementation scenarios to avoid polluting the first memory architecture 218 with use-once-cache-lines (e.g., cache lines that are accessed just once within a certain time period) that are prevalent in various workloads and/or memory access patterns.

In one or more implementations, the cache controller 152 implements a victim cache model in which a cache line is installed in the last level cache 212 in response to a cache eviction from a higher cache level 208, e.g., the level 2 cache. Additionally or alternatively, the cache controller 152 implements a demand cache model in which a cache line is installed in the last level cache 212 in response to a cache miss in the last level cache 212. In accordance with the demand cache model, the cache controller 152 fetches a cache line from the memory 206 in response to a cache miss in the last level cache 212, and installs the cache line in the last level cache 212. As used herein, an installation cache line refers to a cache line that is installed in the last level cache 212 responsive to a cache eviction from the level 2 cache or a cache miss in the last level cache 212. Further, installation cache lines differ from prefetched cache lines which are inserted into the last level cache 212 based on a prediction that the cache lines are going to be accessed in the future.

Any one or more of a variety of installation policies are implementable by the cache controller 152 to insert installation cache lines in the last level cache 212. In one example installation policy, the cache controller 152 inserts installation cache lines into the first memory architecture 218 of the last level cache 212. In another example installation policy, the cache controller inserts installation cache lines into the second memory architecture 220 of the last level cache 212. In yet another example installation policy, the cache controller 152 determines whether to insert installation cache lines into the first memory architecture 218 or the second memory architecture 220 based on reuse predictions and/or spatial locality predictions.

As part of this, the cache controller 152 includes logic (e.g., a reuse prediction algorithm) for predicting whether a cache line will be accessed again within a threshold amount of time (e.g., a threshold number of instruction cycles) based on previous memory access patterns. Here, the cache controller 152 inserts an installation cache line into the first memory architecture 218 rather than the second memory architecture 220 in response to predicting that the installation cache line will be accessed again within the threshold amount of time. Contrarily, the cache controller 152 inserts an installation cache line into the second memory architecture 220 rather than the first memory architecture 218 in response to predicting that the installation cache line will not be accessed again within the threshold amount of time.

Additionally or alternatively, the cache controller 152 includes logic (e.g., a spatial locality prediction algorithm) for predicting a number of bytes within a cache line that will be accessed based on memory access patterns. Here, the cache controller 152 inserts an installation cache line into the first memory architecture 218 rather than the second memory architecture 220 in response to predicting that at least threshold number of bytes of the installation cache line will be accessed. Contrarily, the cache controller 152 inserts an installation cache line into the second memory architecture 220 rather than the first memory architecture 218 in response to predicting that less than the threshold number of bytes of the installation cache line will be accessed.

Notably, cache lines exhibiting increased spatial locality and increased reuse rates are accessed with increased frequency. Thus, by installing these cache lines into the first memory architecture 218, the cache controller 152 increases cache hit rate in the first memory architecture 218. Since the first memory architecture 218 exhibits decreased memory access latency relative to the second memory architecture 220, increasing cache hit rate in the first memory architecture 218 improves overall memory access latency and performance of the device 202.

As mentioned above, the cache controller 152 manages cache prefetching. As part of this, the cache controller 152 predicts cache lines that are to be accessed in the future and preemptively loads prefetched cache lines into the last level cache 212. In accordance with the described techniques, the cache controller 152 implements one or more prefetching policies to determine whether a prefetched cache line is to be inserted into the first memory architecture 218 or the second memory architecture 220. One example prefetching policy prefetches cache lines into the first memory architecture 218 and the second memory architecture 220 at different rates. For instance, the cache controller 152 prefetches cache lines in the first memory architecture 218 less frequently than the second memory architecture 220. As a specific and non-limiting example, the prefetching policy includes a predefined ratio specifying that a first percentage of prefetched cache lines are inserted into the first memory architecture 218 (e.g., twenty percent) and a second percentage of prefetched cache lines are inserted into the second memory architecture 220, e.g., eighty percent. By prefetching more frequently into the second memory architecture 220, the described techniques avoid polluting the first memory architecture with prefetched cache lines that are not ultimately accessed. Instead, the aforementioned swapping policies control whether cache lines are transferred or “promoted” to the first memory architecture 218 based on cache hits to the cache lines.

In another example prefetching policy, the cache controller 152 prefetches a cache line into the first memory architecture 218 or the second memory architecture 220 based on a lookahead distance of the prefetched cache line. Here, a lookahead distance refers to a number of instruction cycles to be executed before the prefetched cache line is predicted to be accessed. Notably, as lookahead distance of a cache line increases, the likelihood of the cache line ultimately being accessed decreases. Given this, the cache controller 152 prefetches cache lines having less than a threshold lookahead distance (e.g., that are predicted to be accessed fewer than a threshold number of instruction cycles in the future) into the first memory architecture 218. Contrarily, the cache controller 152 prefetches cache lines having greater than a threshold lookahead distance (e.g., that are predicted to be accessed at least the threshold number of instruction cycles in the future) into the second memory architecture 220. In other words, the described techniques prefetch cache lines into the first memory architecture 218 that are more likely to be accessed by an application running on the processor 204, which increases cache hit rate in the first memory architecture 218 and improves performance of the device 202.

In one or more implementations, the cache controller 152 leverages the transfer of cache lines between the first memory architecture 218 and the second memory architecture 220 as hints to aid in making prefetching decisions. As previously discussed, a threshold number of cache hits to a cache line that is present in the second memory architecture 220 triggers promotion of the cache line to the first memory architecture 218. Given this, the cache controller 152 determines to prefetch one or more nearby cache lines that are close to the promotion cache line within the system's memory address space into the last level cache 212.

The cache controller 152 includes support for way partitioning in various implementations. Broadly, way partitioning involves allocating different ways of a cache level 208 to different applications running on the processor 204 and/or different cores of the processor 204. In one example, the cache controller 152 assigns ways of the first memory architecture 218 and ways of the second memory architecture 220 to applications based on whether the applications are memory-intensive or compute-intensive. Consider an example in which an application running on the processor 204 is to be allocated four ways of the last level cache 212. If the application is classified as compute-intensive (e.g., estimated to invoke at least a threshold amount of processing resources), then the cache controller 152 allocates three or four ways of the first memory architecture 218 and one or zero ways of the second memory architecture 220 to the application. If the application is classified as memory-intensive (e.g., estimated to invoke at least a threshold amount of memory resources), then the cache controller 152 allocates three or four ways of the second memory architecture 220 and one or zero ways of the first memory architecture 218 to the application. In other words, the cache controller 152 allocates more ways of the first memory architecture 218 to compute-intensive applications, and allocates more ways of the second memory architecture 220 to memory-intensive applications.

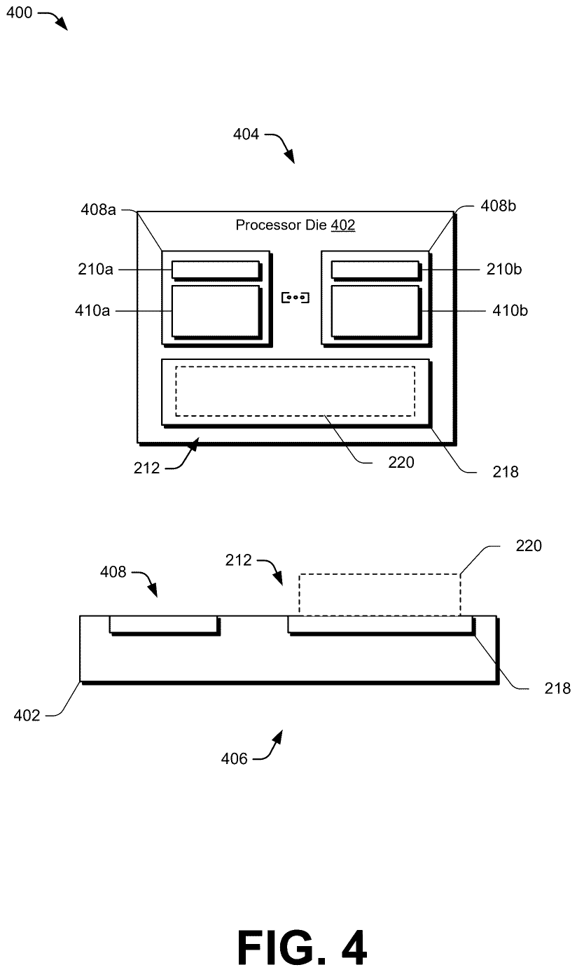

FIG. 4 depicts a non-limiting example 400 of a processor die 402 in accordance with one or more implementations. The example 400 includes a top view 404 of the processor die 402 and a side view 406 of the processor die 402. The processor die 402 (e.g., of the processor 204) is illustrated as including a plurality of processor cores 408, such as processor cores 408a, 408b. Each of the processor cores 408 include a level 1 cache 210 (e.g., level 1 caches 210a, 210b) and a level 2 cache, e.g., level 2caches 410a, 410b. Moreover, the processor cores 408 share a last level cache 212, e.g., a level 3 cache.

In the example 400, the second memory architecture 220 (e.g., DRAM) is integrated into the processor die 402 via three-dimensional stacking. For example, the first memory architecture 218 (e.g., an SRAM chip) is built directly into the processor die 204 (e.g., silicon die) alongside the processor cores 408. Moreover, the second memory architecture 220 (e.g., a DRAM chip) is stacked vertically on top of the processor die 402. In one or more implementations, additional layers are arranged between the processor die 402 and the second memory architecture 220 (e.g., the DRAM chip), such as dielectric layers for electrically isolating individual layers. In other variations, the processor die 402 and the second memory architecture 220 are stacked adjacent to each other on a common substrate, such as but not limited to a silicon interposer, an organic substrate, a glass substrate, or a ceramic substrate.

Although depicted as integrated in the processor 204 via three-dimensional stacking on top of a processor die 402 of the processor 204, this example is not to be construed as limiting. In at least one variation, for instance, the second memory architecture 220 is integrated directly into the processor die 204 alongside the processor cores 408 and first memory architecture 218.

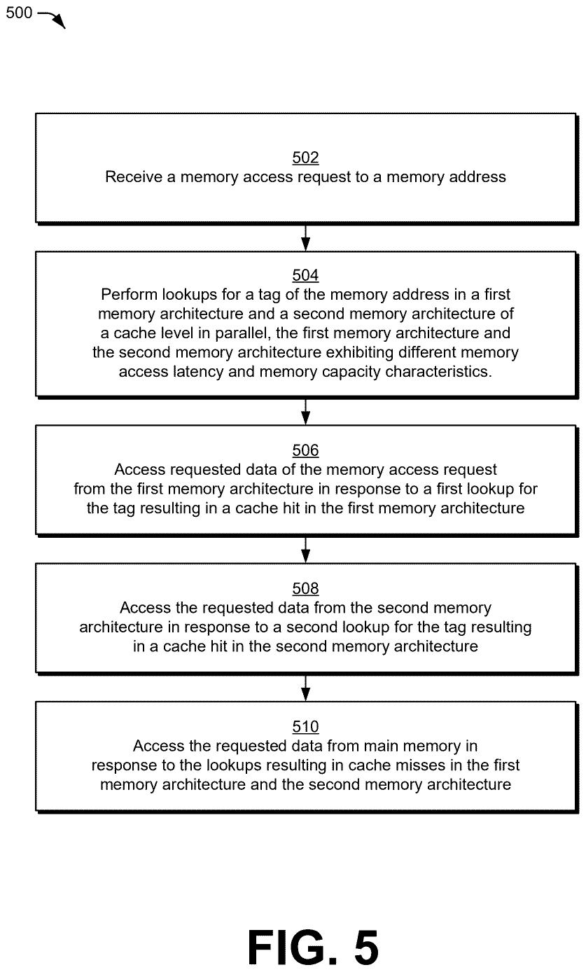

FIG. 5 depicts a procedure 500 in an example implementation of mixed memory architecture cache level. In the procedure 500, a memory access request to a memory address is received (block 502). By way of example, the cache controller 152 receives a memory access request 214 to a memory address 216, e.g., from an application running on the processor 204.

Lookups for a tag of the memory address are performed in a first memory architecture and a second memory architecture of a cache level in parallel, and the first memory architecture and the second memory architecture exhibit different memory access latency and memory capacity characteristics (block 504). For example, the last level cache 212 of the cache system 150 includes a first memory architecture 218 and a second memory architecture 220. The first memory architecture 218 (e.g., SRAM) exhibits decreased memory access latency and decreased memory capacity relative to the second memory architecture 220, e.g., DRAM. Here, the cache controller 152 performs a lookup 310 for the tag of the memory address 216 in the tag array 302 of the first memory architecture 218, and the cache controller 152 performs a lookup 312 for the tag of the memory address 216 in the tag array 306 of the second memory architecture 220. The lookups 310, 312 are parallel operations 322. That is, the cache controller 152 performs the lookups 310, 312 in parallel.

Requested data of the memory access request is accessed from the first memory architecture in response to a first lookup for the tag resulting in a cache hit in the first memory architecture (block 506). By way of example, the lookup 310 in the first memory architecture 218 results in a cache hit 314. In response to the cache hit 314, the cache controller 152 accesses the data identified by the memory address 216 from the data array 304 of the first memory architecture 218.

Requested data of the memory access request is accessed from the second memory architecture in response to a cache hit in the second memory architecture (block 508). For instance, the lookup 312 in the second memory architecture 220 results in a cache hit 318. In response to the cache hit 218, the cache controller 152 accesses the data identified by the memory address 216 from the data array 308 of the second memory architecture 220.

The requested data is accessed from main memory in response to the lookups resulting in cache misses in the first memory architecture and the second memory architecture (block 510). For example, the lookups 310, 312 both result in cache misses in the first and second memory architectures 218, 220, respectively, e.g., the last level cache miss 324. In response to the last level cache miss 324, the cache controller 152 forwards the memory access request 214 to the memory 206, e.g., to access the requested data from the memory 206.

What is claimed is:

1. A processor comprising:
a cache system having a cache level with multiple memory architectures exhibiting different memory access latency and memory capacity characteristics; and
a cache controller to:
receive a memory access request to a memory address; and
perform lookups for a tag of the memory address in the multiple memory architectures in parallel.

2. The processor of claim 1, wherein the processor is communicatively coupled to a memory, and the cache controller is configured to forward the memory access request to the memory in response to the lookups resulting in cache misses in the multiple memory architectures.

3. The processor of claim 1, wherein a first memory architecture of the multiple memory architectures exhibits decreased memory access latency and decreased memory capacity relative to a second memory architecture of the multiple memory architectures.

4. The processor of claim 3, wherein the cache controller is configured to access requested data of the memory access request from the first memory architecture in response to a lookup for the tag resulting in a cache hit in the first memory architecture.

5. The processor of claim 3, wherein the cache controller is configured to access requested data of the memory access request from the second memory architecture in response to a lookup for the tag resulting in a cache hit in the second memory architecture.

6. The processor of claim 3, wherein the processor is communicatively coupled to a memory, and the cache controller is configured to speculatively forward the memory access request to the memory in response to a first lookup for the tag resulting in a cache miss in the first memory architecture and before a second lookup for the tag has completed in the second memory architecture.

7. The processor of claim 3, wherein the second memory architecture is a dynamic random access memory, the memory access request maps to a row of the dynamic random access memory, and the cache controller is configured to issue an activate command to open the row in a data array of the dynamic random access memory before a lookup for the tag in a tag array of the dynamic random access memory has completed.

8. The processor of claim 3, wherein the cache controller is configured to swap a cache line that contains requested data of the memory access request from the second memory architecture to the first memory architecture in response to a lookup for the tag resulting in a cache hit in the second memory architecture.

9. The processor of claim 3, wherein the cache controller is configured to:
generate at least one of a reuse prediction and a spatial locality prediction for a cache line to be installed into the cache level; and
install the cache line into the first memory architecture or the second memory architecture based on at least one of the reuse prediction and the spatial locality prediction.

10. The processor of claim 3, wherein the cache controller is configured to:
prefetch data into the first memory architecture of the cache level at a first rate; and
prefetch data into the second memory architecture of the cache level at a second rate that is different than the first rate.

11. The processor of claim 3, wherein the first memory architecture and the second memory architecture are configured as set-associative caches having a same number of sets, and the cache controller is configured to perform the lookups in the multiple memory architectures using a same index function.

12. The processor of claim 3, wherein the first memory architecture and the second memory architecture are configured as set-associative caches having different numbers of sets, and the cache controller is configured to:
perform a first lookup for the tag in the first memory architecture using a first index function; and
perform a second lookup for the tag in the second memory architecture using a second index function.

13. The processor of claim 1, wherein one or more of the multiple memory architectures are integrated in the processor via three-dimensional stacking.

14. A device comprising:
a processor including a cache system and a cache controller, the cache system including a cache level having a static random access memory (SRAM) portion and a dynamic random access memory (DRAM) portion, the cache controller configured to:
receive a memory access request to a memory address; and
perform lookups for a tag of the memory address in the SRAM portion and the DRAM portion in parallel.

15. The device of claim 14, wherein the cache controller is configured to:
access requested data of the memory access request from the SRAM portion in response to a first lookup for the tag resulting in a cache hit in the SRAM portion; or
access the requested data from the DRAM portion in response to a second lookup for the tag resulting in a cache hit in the DRAM portion.

16. The device of claim 14, further comprising a memory communicatively coupled to the processor, wherein the cache controller is configured to speculatively forward the memory access request to the memory in response to a first lookup for the tag resulting in a cache miss in the SRAM portion and before a second lookup for the tag has completed in the DRAM portion.

17. The device of claim 14, wherein the cache controller is configured to:
access a cache line of the memory address from the DRAM portion in response to a lookup for the tag resulting in a cache hit in the DRAM portion; and
swap the cache line from the DRAM portion to the SRAM portion based on a counter value of the cache line that indicates a number of cache hits to the cache line.

18. The device of claim 14, wherein the cache controller is configured to prefetch a cache line into the SRAM portion rather than the DRAM portion based on a lookahead distance of the cache line falling below a threshold, the lookahead distance representing a number of instruction cycles to be executed before the cache line is predicted to be accessed.

19. The device of claim 14, wherein the cache controller is configured to prefetch a cache line into the DRAM portion rather than the SRAM portion based on a lookahead distance of the cache line equaling or exceeding a threshold, the lookahead distance representing a number of instruction cycles to be executed before the cache line is predicted to be accessed.

20. A method comprising:
receiving a memory access request to a memory address; and
searching for a tag of the memory address in a first memory architecture and a second memory architecture of a cache level in parallel, the first memory architecture exhibiting decreased memory access latency and decreased memory capacity relative to the second memory architecture.
